(19) United States
(12) Patent Application Publication
(10) Pub. No.: US 2021/0406961 A1
(43) Pub. Date: Dec. 30, 2021

(54) SYSTEM AND METHOD FOR AUTOMATED GENERATION OF DIGITAL ADVERTISEMENTS AND IMAGES

(71) Applicant: David Alexander Feinleib, San Francisco, CA (US)

(72) Inventor: David Alexander Feinleib, San Francisco, CA (US)

(21) Appl. No.: 17/323,159

(22) Filed: May 18, 2021

Related U.S. Application Data
(60) Provisional application No. 63/045,725, filed on Jun. 29, 2020.

(51) Int. Cl. G06Q 30/02; G06F 3/0484; G06N 3/02

(52) U.S. Cl. CPC G06Q 30/0276; G06N 3/02; G06F 3/04845; G06F 3/04842

(57) ABSTRACT

A method of generating advertisements includes accessing a user interface for creating an ad. The method also includes selecting a customer needing ad creation through the user interface and selecting a product related to the ad through the user interface. The method also includes configuring settings for the ad through the user interface and generating an ad preview based on the customer, the product, and the settings.

### CROSS-REFERENCE TO RELATED APPLICATIONS

This application claims priority to provisional application No. 63/045,725, filed on Jun. 29, 2020, entitled System and Method for Automated Generation of Digital Advertisements and Images, to inventor David Alexander Feinleib, the entirety of which is herein incorporated by reference.

### TECHNICAL FIELD

The present disclosure relates to automated generation of digital advertisements and images. More specifically but not exclusively, the disclosure relates to software processes, algorithms, and protocols for the entry of parameters used in the generation of advertisements and images. The systems and methods also apply to the placement of text, shapes, and product images in the generated output files, where the product images are sized properly relative to each other.

### BACKGROUND

Conventionally, much of advertising today is online, particularly with the increased popularity of e-commerce. As a result, the need to create product-based advertisements for web sites and product-based images for social media continues to increase.

To support these efforts, advertisers may desire to combine multiple product images together in a banner advertisement or image, along with various text content (in varying fonts, alignments, sizes, and colors), buttons, background images, etc., and produce the resulting ads/images in various sizes. Moreover, from time to time, these advertisers may desire to update such advertisements or social media images using the same products but with different text or backgrounds to provide a fresh view of their products.

However, producing these ads/images may be time consuming and cumbersome for graphic designers. They may choose the product images, load them into a graphics editor, set the proper size, place the product images in the right place, update the background, add text, format that text, and then may repeat this process for multiple output sizes/dimensions. Also, it may be desired that the product images have transparent backgrounds so they can be placed adjacent or overlapping with each other or placed on top of a background image or background color, or shape.

### SUMMARY

In some embodiments, a method of generating advertisements includes accessing a user interface for creating an ad. The method also includes selecting a customer needing ad creation through the user interface and selecting a product related to the ad through the user interface. The method also includes configuring settings for the ad through the user interface and generating an ad preview based on the customer, the product, and the settings.

In various embodiments a system for generating advertisements includes a processing unit running a computer program. The computer program is configured to carry out the steps of generating a user interface for creating an ad; receiving a customer needing ad creation through the user interface; receiving a product selection related to the ad through the user interface; receiving configuration settings for the ad through the user interface; and generating an ad preview based on the customer, the product, and the settings.

In other various embodiments, a system includes a frontend, a backend, a database, and an image files folder. The system also includes a dimensions and identification mapping loader and a file generator. The system is further configured to automate the generation of digital advertisements and images.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is an example block diagram of the system in accordance with an illustrative embodiment.

FIG. 2 is an example user interface index screen in accordance with an illustrative embodiment.

FIG. 3 is an example user interface ad creation screen in accordance with an illustrative embodiment.

FIG. 4 is an example of an ad generation process in accordance with an illustrative embodiment.

FIG. 5 is an example of an image converting process in accordance with an illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

In accordance with various embodiments, a solution to improve the generation of digital advertisements and images may be a web-based system for automated generation and delivery of online banner ads/images.

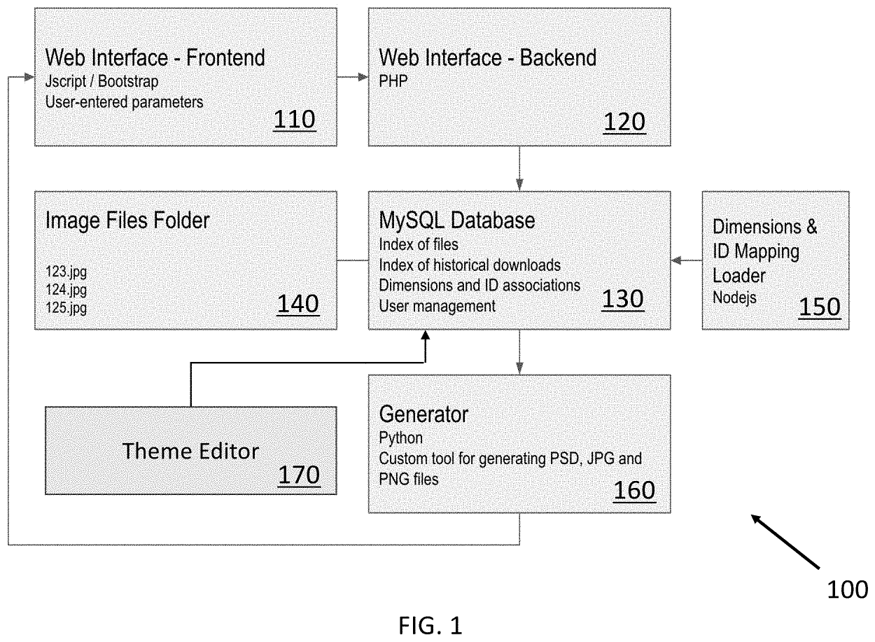

Referring now to FIG. 1, a system 100 may include a frontend 110, a backend 120, a database 130, an image files folder 140, a dimensions and an ID mapping loader 150, and a generator 160, etc. The system 100 may be configured to save a history of outputted ads/images and may facilitate improved editing and re-generation with changes at a later date. The frontend 110 may be configured to provide a web interface for users to upload or select product images and configure various settings. The system 100 may include a user login mechanism configured to control access to the system and to maintain a user history specific to each user. The system 100 may contain a delivery mechanism that may automatically deliver resulting files to specific endpoints such as but not limited to a website, a cloud-based file sharing service (e.g., SharePoint, Dropbox, Box or Google Drive), etc. In addition, the system 100 may tag settings and/or output for approval by one or more approvers; for example, text may be sent for approval by a marketing team member to a legal department team member before final ads may be generated.

The backend 120 may provide specialized functionality including but not limited to, automated conversion of backgrounds of product images from solid to transparent, automated calculation of product image size, placement of images, text, and other graphics such as rectangles and circles onto the resulting image, automated production of resulting banner advertisements in multiple sizes or as images suitable for social media platforms (e.g., Instagram, Twitter, Facebook, etc.), etc. Moreover, the system may generate output files in multiple image output formats, including, but not limited to, JPG, PNG, GIF, and HTML5 formats typically utilized by web sites and the PSD and AI format typically desired by graphic designers.

### Web Interface and Configuration

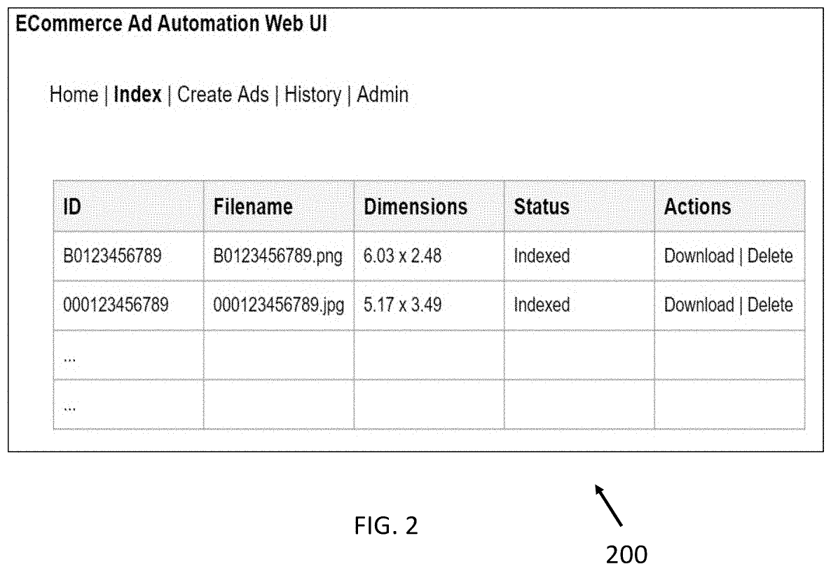

The system 100 may include a web-based interface 200, depicted in FIG. 2, for entering key configuration data for the output rather than using a full-fledged graphic editor. In some embodiments, the web-based interface 200 may allow graphic designer and non-graphic designer users to generate digital advertisements and images without having to use or learn detailed image editing software programs.

The web-based interface 200 may include various pages including, but not limited to, home 210, index 220, create ads 230, history 240, admin, etc. FIG. 2 thus depicts an example page of an example web-based interface with links to other functionality. The subject matter is not limited to the example index pages depicted in FIG. 2.

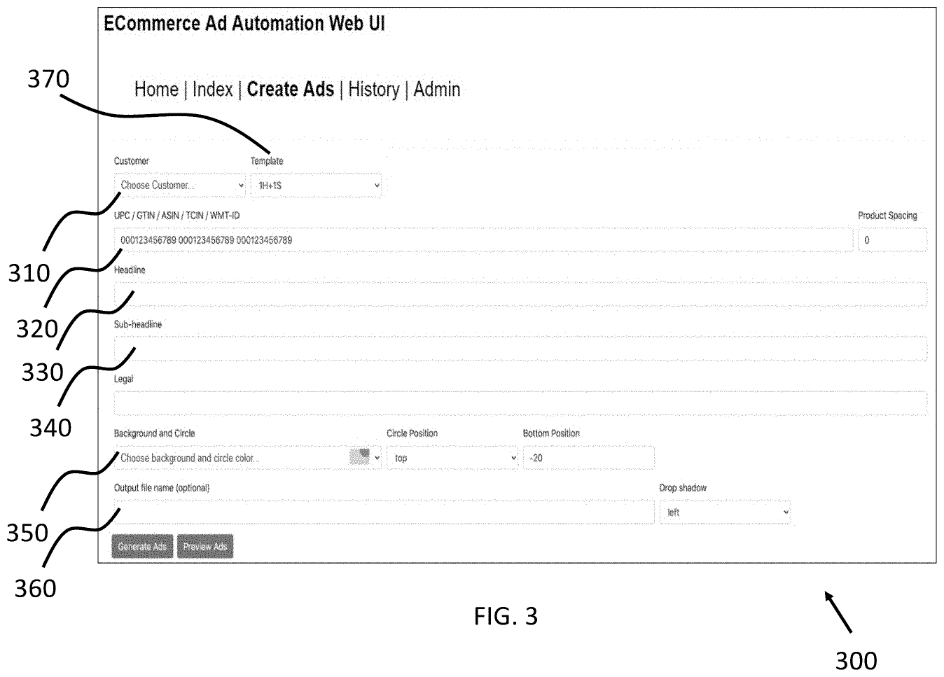

Referring now to FIG. 3, the system 100 may include an Ad creation UI 300. Ad creation UI may include one or more configuration settings for creating an ad. For example, a user is able to choose a customer from drop down menu 310 to create an ad for a product identified by a product code 320. Ad creation UI 300 may include a variety of settings (some depicted in FIG. 3 which is only an example of a create ads UI) used for creation of an ad for the customer including but not limited to:
Product Image selection, which may be made by one or more filenames or product identifiers 320 such as Universal Product Code (UPC) values, Global Trade Item Number (GTIN) values, Amazon Standard Identification Number (ASIN) values, Target.com Item Network (TCIN) values, Walmart Item Number, Tool ID values, etc.
Text entry boxes for Headline 330, Sub headline 340, Call to Action and Button text, etc.; along with font alignment, font, size, color, etc.
Button container values (a container may be a line bordering the button text): width, color, rounding, and padding, etc.
Button images
Background colors, background images 350, etc.
Retailer logo files
Compression sizing
Output filename 360
Output effects including image mirror, shadow, opaque, fade, etc.

### Preview and Visual Editor

The system 100 may include a visual preview that shows the results of a user's image selections, text entries, field selections, color choices, etc. Such preview may be an approximate representation of the actual output that will be generated. A secondary preview may show the actual outputted graphical file in the user interface. The preview functionality may support an editing mode, wherein the user can move images, rotate them, or resize them, while staying within the configured template parameters.

For animated banners, the visual editor may also be used to specify the starting and ending positions of the image elements, as well the form of movement, if any (such as slide, fade in, etc.)

### File Output

When producing file output, the system 100 may generate output in various formats such as PNG, JPG, GIF, HTML5, PSD and AI formats, among others. Accompanying such graphics/design related output files may be various supplementary files, such as XLSX files that provide information related to the output. Such output files may include text for each field in the graphical output files (for example text for fields like Header1 Text, Header2 Text, Subheader1 Text, Legal Text, and so on). Such output files may also include multiple variations of such text, or versions of such text in multiple languages. Such output files may also include reporting information for scoring the quality of the output, for example the content of text fields adhering to certain minimum or maximum character count requirements per field.

### Output Templates

A user of the system 100 may configure any of the above settings, and the system may store pre-configured versions of these settings as templates. Templates may be specific to each e-commerce retailer and the pre-configuration settings and may include settings such as specific colors, font sizes, fonts, image placements; and shapes, such as circles or rectangles, on the resulting ad canvas/image, etc.

In some embodiments, each template may store a pre-specified position of an object (e.g., a circle, rectangle, etc.) and, based on the background color selection chosen by the user, may automatically select a retailer-approved corresponding object-color selection.

In some embodiments, the system may use a color histogram to suggest a color for a background or object in the image based on the colors present in an image. For example, if the system detects that a certain color is more prevalent or common in the image than the other colors, the system may suggest that that color be used for a background or objects in the image.

Historically, a graphic designer would configure each of these settings manually for each advertisement, which was a time-consuming task. Using the disclosed system, this activity may be performed automatically, saving time and conserving computing resources.

### Templates Configuration

Some templates may be pre-built into the system. However, from time to time, users may desire to create their own template settings. An admin page may allow the user to configure such settings and save them as a named template, which may then be added to the Ad Creation view using drop-down menu 370. The user may also edit existing templates or delete them. Some templates may be tagged as system templates, available to all companies and their users, while other templates may be custom, created by a user that is a member of a company, with the resulting template being available only to other users who are members of that company (or a team within that company).

In addition to configuration via user interface, the system may also read PSD files and generate intermediary JSON files that may describe the text, image, and shape layers in the PSD file. The frontend may then display these settings in the UI, and the user may make changes and save the template.

Whereas templates provide for complete configuration of every aspect of a potential output ad, themes are various ways to extend existing templates. Examples of themes are: Fall Theme, Winter Theme, Spring Theme, Summer Theme, Back to School Theme, and so on. Themes allow users to maintain the existing template layout, while quickly and easily configuring and saving pre-set color options and background images.

Users may use a built-in Theme Editor 170 of system 100 to add more themes by creating a theme from scratch or by clicking a button in a user interface to make a copy of an existing theme to start from. The Theme Editor may allow viewing a list of themes, editing an existing theme, deleting themes, renaming themes, copying themes, and changing the order of themes. Themes may also be temporarily hidden, so they are not visible in the banner-creation user interface but are still present in the system. Themes may be made available on a system-wide basis or can be created custom and only made available to specific users, teams or uses who are members of a company.

The themes may contain specific color settings, one or more pre-defined background images; specific font options, and optionally specific icons or images that can be associated with each theme. The theme editor may have an administrative web interface for configuring the background image(s), color settings, available fonts, and icon/image selections. It would be nice to add a diagram for this in the drawings show this process.

Because templates may come in multiple sizes, for example, 320×240, 300×40, etc. the system 100 may be configured to support multiple ways to handle background images. 1) A user interface is provided for selecting the template size to which the uploaded background image corresponds. 2) The system can intelligently determine which template size a particular background image corresponds to based on the dimensions of the background image. 3) The system can also work with one sized background image for multiple template sizes, by either a) use the area of the background image that will fit into the selected template size or b) using the center of the background image with dimensions corresponding to the template size.

The system may log/store an audit trail of created themes, edits/changes to themes, and may provide a user interface to review such changes.

### Automated Product Sizing

In some embodiments, product images containing objects that may be different sizes (e.g., a pair of sunglasses and a backpack) may be provided as source images of the same size/resolution. For example, a high-resolution photo of the sunglasses and a high-resolution photo of the backpack may both typically be provided as images in 3000×3000 resolution. However, if these images are resized to fit, for example, on a banner ad that is 160×600 pixels (width x height) and are both sized down equally from the original 3000×3000 resolution, the images may appear to have incorrect relative sizes when placed next to each other in the resulting banner ad, as compared with their actual physical sizes.

Graphic designers typically “eyeball” the relative sizes of images containing objects so that when placing the images next to each other, the images may be resized from their original same-size source photographs down to relative sizes in the resulting banner ad or social media image. For example, a designer may know that sunglasses may be generally smaller in size than a backpack, so the designer may further reduce the size of the sunglasses relative to the backpack. However, this approach may be time consuming and error prone.

In accordance with various embodiments, the system herein may be configured to use an input file containing real-world physical dimensions for each product to determine the relative resulting sizing of the images. The real-world physical dimensions may be stored in a database and looked up using one of the previously mentioned product identifiers (such as UPC, GTIN, ASIN, TCIN, filename, etc.). This automated resizing may be based on actual physical dimensions of each product, even when the original source images may have the same or similar resolutions and may provide significant time savings in output production and highly accurate relative product sizes in the resulting output images.

The software algorithm may first identify a largest image of the one or more images to be placed on the output image canvas. This image may be resized down to a maximum size specified for the given output template. The other product images may then be resized down using their relative, respective dimensions.

For example, if a first image of a first item and a second image of a second item are to be placed adjacent to each other at a relative scale, an example algorithm first may look up the physical image sizes of the first item and the second item in the database. The algorithm may then determine the larger item of the first item and the second item. The algorithm may then use a first item area (i.e., equal to a first item height multiplied by a first item width) and the second item area (i.e., equal to a second item height multiplied by a second item width) to generate a ratio of the area or size of the second item relative to the first item, wherein second item area is a percentage of the first item area. For example, if the first item has real-world dimensions of 8 inches×12 inches and the second item has real-world dimensions of 3 inches×6 inches the relative areas of the first item and the second item may be 96 square inches: 18 square inches. In this example, the algorithm may maintain the second item's size at a ratio of 18.75% of the first item's size. While a designer, as mentioned, may perform this relative sizing manually, the example software algorithm described may perform the sizing calculation automatically and may handle the same calculation for a large number of images.

### Automated Output Generation

Based on the settings defined for a given template and/or the settings input by the user via the web interface, the system 100 may generate a plurality of output files, including the placement of the text, determination of text layers, placement of shapes, inclusion of background color or background image, etc. for each respective output file.

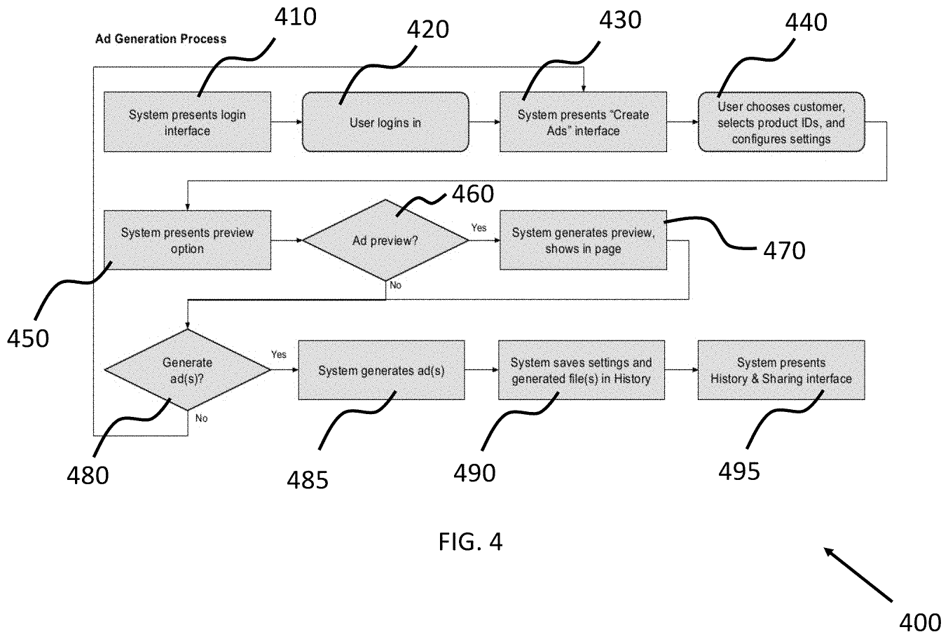

The system 100 may be configured to perform an advertisement generation method 400, an example of which is depicted in FIG. 4. Method 400 includes but is not limited to a number of process steps. For example, method 400 is initiated by system 100 presenting a login interface to a user (process 410). A user may then login (process 420). The system 100 then presents a create ads interface (process 430) such as but not limited to the interface 300 depicted in FIG. 3. The user selects and inputs various data including but not limited to customer, product IDs, and configuration settings (process 440). The system 100 may then present an option to present a preview of the ad (process 450) the choice being performed in process 460. If the user requests a preview, the system 100 generates a preview which is shown as it would be displayed on the page (process 470). After previewing the ad, the user is given the choice as to generating the actual ad (process 480). If the user is not ready, the user is reverted to the ad creation interface or process 430 to continue with creating the ad. Alternatively, the user opts to generate the ad (process 485) and the ad is generated for presenting to a consumer. System 100 then saves the ad settings and generates a history file (process 490). The system 100 then may present a History and Sharing Interface (process 495). Various additional steps and various ordering of steps may be used without departing from the subject matter of the disclosure.

When producing file output, the system may generate output in various formats such as but not limited to PNG, JPG, GIF, HTML5, PSD and AI formats, among others.

Accompanying such graphics/design related output files may be various supplementary files, such as XLSX files that provide information related to the output. Such output files may include text for each field in the graphical output files (for example text for fields like Header1 Text, Header2 Text, Subheader1 Text, Legal Text, and so on). Such output files may also include multiple variations of such text, or versions of such text in multiple languages. Such output files may also include reporting information for indicating the quality of the output, for example the content of text fields adhering to certain minimum or maximum character count requirements per field. Such output files may also include various other types of information related to the ad without departing from the scope of the disclosure.

### History of Generated Files

Each time an output advertisement or social media image may be generated, the system 100 may produce files in JPG/PNG or PSD format. However, without the use of the system 100 disclosed herein, a user desiring to make a change and generate a new ad would ordinarily open the PSD file in a graphic editing software program and fill in updated colors, change the fonts, replace images, etc. The history of generated files may provide a table view of the outputted ads/images. It may also separately store the settings associated with the generated file(s) in the database 130. Using the system 100, the user may edit a generated image, which may load the settings from loader 150 for that generated image, allowing the user to easy to make changes to previously generated ads without having to start from scratch and thus saving time and resources.

### Version Control

After an initial version of an ad or output image is created, users may create many follow-on versions. The system may store these versions together so that the user may see many or all of the versions and may pick any historical version that was saved for download or re-editing.

### Intermediary JSON Data

The intermediary JSON data may be generated by the frontend 110 as a way to deliver output configuration information to one or more backend image generation tools. A benefit of this may be that different tools may then be used to generate different kinds of output, with each tool reading from the same JSON data. The JSON data may also be usable in reverse. A file reader, implemented by the system, may read PSD, AI or XLSX format files and may generate JSON from them. The system 100 may then read such JSON files and display the settings for those files in the UI, as described above.

### Automated File Retrieval

In some embodiments, (i) product images may sometimes be stored in in-house file repositories or digital asset management systems. In some embodiments, (ii) product image files may be retrieved from web sites. In some embodiments, (iii) users may desire to upload product images from their desktop or mobile device.

In embodiments (i) and (ii), given a list of URLs, which may be provided to the system via a CSV file, XLSX file, Application Programming Interface (API) call, or edit box in a web page, the system may download the image at each URL. A benefit of this method may be that the user may provide a list of URLs rather than having to provide a set of actual files, which may be large and time consuming for the customer to transfer.

The provided list may contain one or more identifiers for the product image in the form of, for example, a GTIN, UPC, ASIN, TCIN, Walmart Tool ID value, etc. After retrieving the file at the URL, the system may rename the file according to one of the provided IDs and may store the file. The system 100 may add a record of that file to its database so that the file may be found later or associated with other IDs. In embodiment (iii), the user may upload images directly to the system via a file upload button or drag and drop interface on a system web page. In some embodiments, the uploaded files may contain product images that may be placed on non-transparent backgrounds (since product images may be photographs of actual products), making it difficult to overlay the product images on top of each other or on top of background colors or images. This issue is described in further detail below.

When automatically retrieving image files, the system 100 may encounter files with the same names or IDs as existing files. In this case it will need to determine which image files have changed. In some cases, the originating system, such as a digital asset management system, may indicate which files have changed. But in other cases, no flag/indication may be provided, so the system will need to make a determination about whether a file is new or not. The reason for determining this is so that a) files that have not changed do not need to be reimported, saving time and compute resources and b) files that have not changed do not need to be reprocessed, e.g., to have backgrounds removed or to have images be resized or trimmed, or to be reviewed for accuracy. However, a simple checksum (for example) comparing two image files is not practical, because image files may change very slightly (e.g., a few pixels may change) but the image is still the same image and does not need to be re-processed. In this case, a color histogram is used to compare the two image files, the existing image file and possible-new image file. A threshold is set in the system, such that if the histogram matches above the threshold, then the image is considered unchanged and is not reimported/re-processed. Such evaluation also enables the system to provide a report of changed/updated images to the user/client.

### File Transparency/Conversion

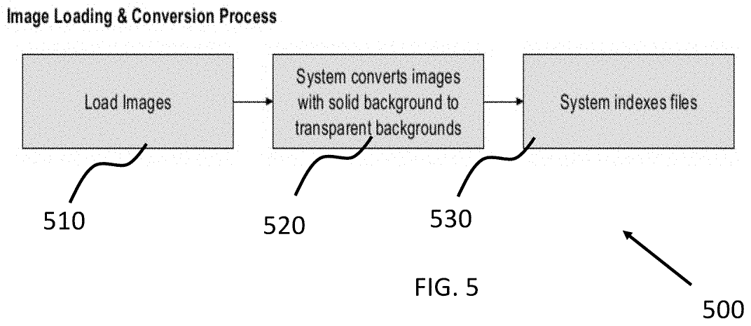

Referring now to FIG. 5, the system 100 may be configured to perform the following example method 500 or image loading and conversion.

The system 100 may utilize any of a variety of methods for addressing the issue of background transparency after uploaded images are loaded into a file queue of images to be processed. Each of the various methods include the steps of loading images to be converted (process 510). The system 100 then converts images with solid backgrounds to images with transparent backgrounds (process 520). The system then indexes the transparent background images for later use (process 530).

A first example method which may be used in the conversion process of FIG. 5, may include using files that have been manually converted to have transparent backgrounds to train an algorithm that may automatically convert images to have background information. In the training, the algorithm may compare each input (non-transparent) and output (transparent file) file to identify characteristics of where a transparent image background may be applied. An example of edge cases that the algorithm is trained on may include lack of edges of the product image where the product image and background color may be the same or very similar where the edge would be. After the training, the image conversion algorithm may be used to convert additional images to have transparent backgrounds. Such training may be carried out using a variety of artificial intelligence techniques, such as various neural networks as well as a variety of optimization techniques.

A second example method may be a human approach, where the user may retrieve one or more images from the queue and may use a manual editing tool, integrated in the web interface of the system, to make the appropriate sections of each area transparent. The user may then save the updated image, and the system may add it to the approved files that may be selected for use when generating ads or output images. The user may also download any queued image (or images) and may edit the queued image in a separate image editing application, and then upload the resulting file(s) to the system.

The first and second example methods may include calculating and/or applying a confidence value to an image based on an applied transparency, the confidence value denoting the likelihood that the transparency of the image has been correctly applied.

### Approval Handling

Larger brands tend to have multiple approvals that may occur before an ad can be shown on a web site. For example, a project may be initiated by a user with simply a project name and one or more product images to be used for that project. The system may then route the project to, for example, a marketing user to provide text to be used for the ads. Once ads are completed, they may be routed, for example, to a legal department for final approval before being submitted for presentation on web sites. Routing, in these and other embodiments, may mean that one or more users may be notified via email/messaging apps such as Slack or Microsoft Teams, Desktop notifications, etc., that there may be a project where their input is needed or sought. The one or more users may click through the notification link to review the materials and may provide comments and/or may approve the project. The system may also provide a list of projects and their current status (e.g., what state they are in, awaiting legal approval, marketing approval, etc.) The approval process may be enabled/disabled via a system setting or on a per-project basis.

### File Delivery

Once the output files may be ready for delivery, they may be downloaded. Or, in some embodiments, the system may automatically send the files to user-specified endpoints, which may be one or more of cloud-based file services such as Google Drive, Microsoft SharePoint, Dropbox, Box, etc.; a cloud-based storage system such as Amazon S3; an internal file sharing system; a file transfer protocol (ftp) server; an API endpoint provided by a web site that wants to receive such files, etc. The delivery status of the files may be updated in the system UI.

### User Management

The system 100 may include user management, which may control access to the system based on an email address and password. Such passwords may be hashed for storage in the database. Login information may be transferred using secure HTTPS/SSL.

The file generation history may be specific to each user but may also be shared with a team. The system may contain an interface for creating teams, adding team members to the teams (referencing their names or email addresses), and sharing generated files with specific users or one or more teams.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g., “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A method of generating advertisements, comprising:
accessing a user interface for creating an ad;
selecting a customer needing ad creation through the user interface;
selecting a product related to the ad through the user interface;
configuring settings for the ad through the user interface; and
generating an ad preview based on the customer, the product, and the settings.

2. The method of claim 1, further comprising:
generating the ad based on the customer, the product, and the settings.

3. The method of claim 1, wherein selecting the product includes accessing an image of the product.

4. The method of claim 3, further comprising:
converting the image to an image with a transparent background.

5. The method of claim 4, wherein the converting is carried out using an artificial intelligence algorithm.

6. The method of claim 4, wherein the converting is carried out using a neural network algorithm.

7. The method of claim 1, further comprising:
generating intermediary JSON files from alternative file formats.

8. The method of claim 1, wherein settings include textual information.

9. The method of claim 1, wherein the textual information includes at least one of headlines and sub headlines.

10. The method of claim 1, wherein the textual information includes textual formatting information.

11. The method of claim 1, wherein at least some of the settings are stored in a template.

12. The method of claim 1, wherein selecting the product includes accessing a product file through a product identifier.

13. A system for generating advertisements, comprising:
a processing unit running a computer program, the computer program configured to carry out the steps of:
generating a user interface for creating an ad;
receiving a customer needing ad creation through the user interface;
receiving a product selection related to the ad through the user interface;
receiving configuration settings for the ad through the user interface; and
generating an ad preview based on the customer, the product, and the settings.

14. The system of claim 1, further comprising:
the computer program carrying out the step of generating the ad based on the customer, the product, and the settings.

15. The system of claim 1, wherein the product selection includes accessing an image of the product.

16. The system of claim 15, further comprising:
the computer program carrying out the step of converting the image to an image with a transparent background.

17. The system of claim 16, wherein the converting is carried out using an artificial intelligence algorithm.

18. The system of claim 1, wherein the settings include textual information.

19. The system of claim 1, wherein the settings include output file compression sizing.

20. A system comprising:
a frontend;
a backend;
a database;
an image file folder;
a dimensions and identification mapping loader; and
a file generator,
wherein the system is configured to automate the generation of digital advertisements and images.
